(19) United States
(12) Patent Application Publication
(10) Pub. No.: US 2018/0003446 A1
(43) Pub. Date: Jan. 4, 2018

(54) METHOD FOR MANUFACTURING HEAT STORAGE DEVICE, METHOD FOR MANUFACTURING HEAT STORAGE MATERIAL, HEAT STORAGE MATERIAL, AND HEAT STORAGE DEVICE

(71) Applicant: KITAGAWA INDUSTRIES CO., LTD., Aichi (JP)

(72) Inventors: Hiroto YOSHINO, Aichi (JP); Teruaki YUOKA, Aichi (JP)

(21) Appl. No.: 15/635,394

(22) Filed: Jun. 28, 2017

(30) Foreign Application Priority Data
Jun. 30, 2016 (JP) 2016-130699

(51) Int. Cl. F28D 20/02; B23P 15/26

(52) U.S. Cl. CPC F28D 20/02; B23P 15/26

(57) ABSTRACT

Provided is a method for manufacturing a heat storage device, the heat storage device including a heat storage material that contains inorganic powder and sodium acetate, the heat storage material undergoing a phase change between a liquid state and a solid state; a heat storage material container configured to enclose the heat storage material; a nucleation device configured to phase-change the heat storage material from a liquid state to a solid state; the method including forming a heat storage material that is particulate and in a powder/granular form by mixing the sodium acetate and the inorganic powder, and filling the heat storage material container with the particulate heat storage material obtained in the forming a particulate heat storage material.

### CROSS-REFERENCE TO RELATED APPLICATIONS

This application claims the benefit of Japanese Patent Application No. 2016-130699 filed Jun. 30, 2016 in the Japan Patent Office, and the entire disclosure of Japanese Patent Application No. 2016-130699 is incorporated herein by reference.

### BACKGROUND

The technology disclosed in the present specification relates to a method for manufacturing a heat storage device, a method for manufacturing a heat storage material, a heat storage material, and a heat storage device.

For example, as a latent heat storage material composed of an aqueous solution of sodium acetate in which sodium acetate is dissolved in water, one described in Japanese Unexamined Patent Application Publication No. 2015-151433A is known. Since such a heat storage material is filled in a heat storage material container and undergoes a phase change by nucleus generation from a supercooled state which is a liquid state, to a solid state in the heat storage material container so as to generate a solidification heat, the heat storage material is utilized as a heat source of a heat storage device for heating a physical object with the solidification heat.

### SUMMARY

Incidentally, when manufacturing this type of heat storage device, it is necessary to fill the heat storage material container with a heat storage material prepared in a form of a highly concentrated aqueous solution in advance. Unfortunately, since the high concentration aqueous solution of the heat storage material is in a supercooled state at ambient temperature, there is a concern that the heat storage material is nucleated due to external stimuli such as vibration during a handling such as storage, transportation, and filling so as to undergo a phase change to a solid state. In cases where the heat storage material has been solidified, a poor handling is caused such that, for example, heating the heat storage material to be melted and returned to a liquid state is necessitated.

For this reason, a handling property when filling the heat storage material container with the heat storage material can be possibly enhanced by nucleating the heat storage material so as to be solidified before filling the heat storage material container therewith and pulverizing the solidified resultant product to form a particulate object. Unfortunately, it is difficult to obtain a free-flowing particulate object from a heat storage material in which sodium acetate is solely dissolved in water by a pulverization using a pulverizer because a softness of the heat storage material is maintained even if solidified at ambient temperature. Under such circumstances, in a field of industry to which this technology pertains, there is no idea of handling the heat storage material in a solid state, and there is an idea that the heat storage material should be handled in a liquid state along with taking cares to control a temperature of the heat storage material so as not to be in a supercooled state as much as possible, bearing in mind that external stimuli do not bring an adverse effect to the heat storage material.

In the present specification, a technology for enhancing the handling properties and storage stability of the heat storage material is disclosed.

### Solution to Problem

The inventors of the present invention have found that even a heat storage material at ambient temperature can be formed in a fine powder state by adding an inorganic powder into sodium acetate. As long as the heat storage material at ambient temperature can be made into powder/granular particles having high fluidity, the heat storage material can be easily filled in the heat storage material container. This facilitates manufacture of the heat storage device. Moreover, since treating the heat storage material as supercooled liquid can be avoided, storage and transportation of the heat storage material are simplified.

The technology disclosed in the present specification provides a method for manufacturing a heat storage device, the heat storage device including: a heat storage material containing sodium acetate and inorganic powder, the heat storage material undergoing a phase change between a liquid state and a solid state; a heat storage material container configured to enclose the heat storage material; a nucleation device configured to phase-change the heat storage material from a liquid state to a solid state; and a heat conductor configured to conduct heat between the heat storage material and an outside of the heat storage material container, the method including: forming a heat storage material that is particulate and in a powder/granular form by mixing the sodium acetate and the inorganic powder; and filling the heat storage material container with the heat storage material that is particulate obtained in the forming a heat storage material.

The forming a heat storage material may include: agitating a solution obtained by adding the inorganic powder into an aqueous solution in which the sodium acetate is dissolved in water; solidifying the heat storage material in a liquid state obtained in the agitating a solution, by cooling the heat storage material so that the heat storage material is in a solid state; and pulverizing the heat storage material in a solid state obtained in the agitating a solution so that the heat storage material is a particulate heat storage material.

According to such configurations, first, a heat storage material in a liquid state is produced by the agitating a solution, and the resultant product is solidified in the solidifying the heat storage material and is subsequently pulverized in the pulverizing the heat storage material. Here, in the pulverizing the heat storage material, if the heat storage material contains no inorganic powder, the particles obtained by pulverizing the heat storage material are in a soft and sticky state even when being solidified. However, by an addition of the inorganic powder, the heat storage material can be a free-flowing powder/granular material.

Alternatively, the technology disclosed in the present specification provides a method for manufacturing a heat storage material including: agitating a solution obtained by mixing water and sodium acetate and thereafter further adding inorganic powder into the solution while heating the solution; solidifying the heat storage material in a liquid state obtained in the agitating a solution so that the heat storage material is in a solid state by cooling the heat storage material; and pulverizing the heat storage material in a solid state obtained in the solidifying the heat storage material so that the heat storage material is in a powder/granular form.

According to such processes, by an addition of the inorganic powder, a solid-state heat storage material can be in a free-flowing powder/granular form so that a heat storage material having a high handling property and storage stability can be obtained. This makes it easier to fill the heat storage material container with the heat storage material, and store the heat storage material for a long period of time and to transport the heat storage material.

When producing a heat storage material, the method for manufacturing a heat storage material further includes compressing a particulate object obtained in the pulverizing the heat storage material into a pellet form.

According to such a method, since a shape and size of the solid-state heat storage material are made uniform, a dust is less likely to fly apart and adhere to other members as compared to a case of the heat storage material remaining in a powder/granular form, whereby the handling property is further enhanced.

Further, the technology disclosed in the present specification provides a particulate heat storage material including sodium acetate and inorganic powder.

According to such a heat storage material, for example, since the heat storage material does not nucleate and undergo a phase-change into a solid state due to external stimuli even under ambient temperature as compared to a liquid-state heat storage material in which sodium acetate is dissolved in water, and further, the heat storage material has fluidity, thereby achieving a high handling property as well as high storage stability.

Alternatively, the technology disclosed in the present specification provides a heat storage device including: a particulate heat storage material in a powder/granular form containing sodium acetate and inorganic powder; a heat storage material container configured to enclose the particulate heat storage material; a heat conductor configured to conduct heat between the particulate heat storage material and an outside of the heat storage material container; and a nucleation device configured to nucleate a liquid-state heat storage material in which the particulate heat storage material is being dissolved.

According to the heat storage device having such a configuration, since the heat storage material is being in a powder/granular solid state, a heat storage device including the heat storage material in a stable state is readily configured as compared to a liquid-state heat storage material that is liable to be nucleated.

According to the technology disclosed in the present specification, a handling property and storage stability of the heat storage material can be enhanced.

### BRIEF DESCRIPTION OF THE DRAWINGS

The invention will be described with reference to the accompanying drawings, wherein like numbers reference like elements.

FIG. 1 is a view illustrating a state in which a particulate heat storage material is being manufactured in forming a heat storage material according to a first embodiment.

FIG. 2 is a view illustrating a state in which a heat storage device is being manufactured in a filling the heat material according to the first embodiment.

FIG. 3 is a view illustrating a state in which a pellet-type heat storage material is being manufactured in compressing a particulate object of a second embodiment.

### DESCRIPTION OF EMBODIMENTS

### First Embodiment

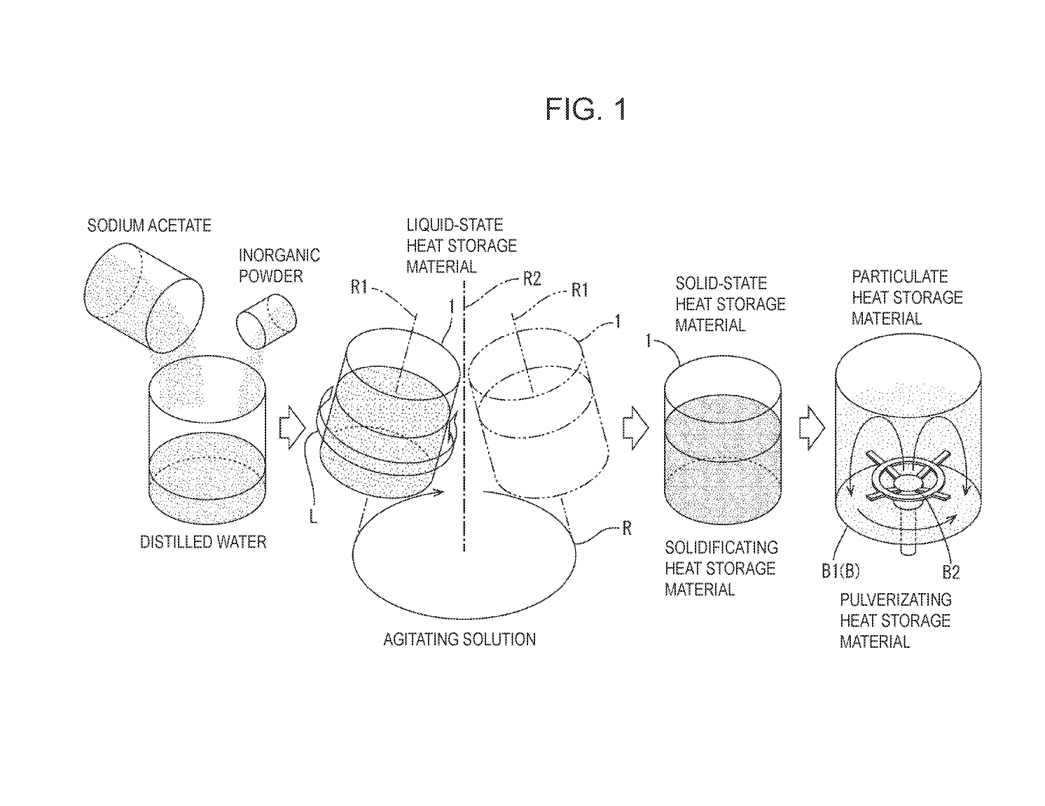

An embodiment according to the technology disclosed in the present specification is described while referencing FIGS. 1 to 3.

The present embodiment describes a method for manufacturing the heat storage material and a method for manufacturing a heat storage device 110.

First, the method for manufacturing the heat storage material will be described.

Raw materials employed in forming a heat storage material for manufacturing the heat storage material are, as shown in Table 1, distilled water, sodium acetate, and inorganic powder.

Sodium acetate anhydrous, sodium acetate trihydrate and the like can be used as the sodium acetate. In the present embodiment, sodium acetate anhydrous is used.

Examples of the inorganic powder include “GC#2500” (manufactured by SHOWA DENKO K.K., silicon carbide, particle size: 5.5 μm), “#200” (manufactured by Konoshima Chemical Co., Ltd., magnesium hydroxide, particle size: 3.5 μm), “N-4” (manufactured by Konoshima Chemical Co., Ltd., magnesium hydroxide, particle size: 1.5 μm, higher fatty acid-based surface treatment), “N-6” (manufactured by Konoshima Chemical Co., Ltd., magnesium hydroxide, particle size: 1.3 μm, higher fatty acid-based surface treatment), “S-6” (manufactured by Konoshima Chemical Co., Ltd., magnesium hydroxide, particle size: 1.0 μm, silane coupling agent surface treatment), “BF083” (manufactured by Nippon Light Metal Co., Ltd., aluminum hydroxide, particle size: 10 μm), “BF013” (manufactured by Nippon Light Metal Co., Ltd., aluminum hydroxide, particle size: 1.2 μm), “BX053T” (manufactured by Nippon Light Metal Co., Ltd., hydroxide aluminum, particle size: 7.0 μm, titanate surface treatment), alumina, boron nitride, silicon nitride, aluminum nitride, and magnesium oxide. These can be employed alone or in combination of two or greater.

TABLE 1

| | Contents with respect to total mass of | | | | |
|---|---|---|---|---|---|
| | Heat storage material | | | | |
| | Sodium | | | | |
| | acetate | Distilled | Inorganic | Inorganic | Type of |
| | anhydrous | water | powder α | powder β | Inorganic |
| | [mass %] | [mass %] | [mass %] | [mass %] | powder |
| Example 1 | 28.67 | 21.33 | 50 | — | A: GC#2500 |
| Example 2 | 28.67 | 21.33 | 40 | 10 | A: GC#2500, B: N-4 |
| Example 3 | 28.67 | 21.33 | 40 | 10 | A: GC#2500, B: N-6 |
| Example 4 | 28.67 | 21.33 | 40 | 10 | A: GC#2500, B: S-6 |
| Comparative | 57.34 | 42.66 | — | — | |
| Example | | | | | |

Note that, it is sufficient for an amount of distilled water with respect to sodium acetate anhydrous to be, for example, from 70 parts by mass to 100 parts by mass, preferably from 74 parts by mass to 96 parts by mass of distilled water per 100 parts by mass of sodium acetate anhydrous.

Further, a content of the inorganic powder may be from 30 mass % to 70 mass %, preferably from 30 mass % to 60 mass %, more preferably from 40 mass % to 50 mass %, with respect to a total mass of the heat storage material.

Furthermore, a ratio of Inorganic powder α and Inorganic powder β may be from 95:5 to 80:20, preferably approximately 90:10.

Additionally, the forming a heat storage material of the present embodiment includes three processes that are agitating a solution, solidifying the heat storage material, and pulverizing the heat storage material, and these processes each will be described below.

In the agitating a solution, as illustrated in FIG. 1, sodium acetate and inorganic powder are added into distilled water stored in an agitating vessel 1 which is a drum-type vessel, and the solution obtained thereby is agitated to produce a liquid-state heat storage material in a semi-flowable liquid state. Note that the liquid-state heat storage material in a semi-flowable liquid state is an example of the heat storage material in a liquid state.

In this agitating a solution, as illustrated in FIG. 1, while the agitating vessel 1 is, for example, left-handed rotated (rotated counterclockwise) about an axis R1 of the agitating vessel 1 to perform a rotation L, the agitating vessel 1 is right-handed rotated (rotated clockwise) about a revolution axis R2 to perform a revolution R so as to almost uniformly mix the distilled water, the sodium acetate, and the inorganic powder. Note that, in this agitating a solution, the agitating vessel 1 is heated so that the obtained liquid mixture may be maintained in a liquid state.

Next, in the solidifying the heat storage material, a physical stimulus is applied to the liquid-state heat storage material after the agitating vessel 1 is cooled to ambient temperature and becomes in a supercooled state so that seed crystals that promote a phase change into a solid substance are generated (nucleated) in a solution. Thereby, an entire of the heat storage material undergoes a phase change from a liquid state to a solid state and thus becomes a solid-state heat storage material.

Next, in the pulverizing the heat storage material, the solid-state heat storage material having been in a solid state in the agitating vessel 1 is taken out in a block state as it stands, and is thrown into a pulverizer B having a pulverization vessel B1 that is larger than the agitating vessel 1. Then, the solid-state heat storage material is pulverized by a rotation of a pulverization blades B2 provided in the pulverization vessel B1 so that a particulate heat storage material in a powder/granular form can be produced. Note that the particulate heat storage material in a powder/granular form is an example of the heat storage material in a solid state.

Note that, in the present embodiment, the forming a heat storage material for manufacturing the particulate heat storage material is performed under three processes that are the agitating a solution, the solidifying the heat storage material, and the pulverizing the heat storage material. However, for example, heating and cooling may be performed while agitating is performed to carry out the solidifying the heat storage material and the pulverizing the heat storage material within an identical process, and solidification by cooling and pulverization may be simultaneously performed to carry out the solidifying the heat storage material and the pulverizing the heat storage material within an identical process. Alternatively, agitating, cooling, and pulverizing may be performed within an identical process.

Specifically, raw materials that are identical to those employed in Example 1 are agitated in an agitating vessel, and the resultant product is cooled as it stands, with a freezer and the like without heating at a temperature below freezing temperature (e.g., not higher than −15° C.) for about an hour and is subsequently pulverized with a pulverizer, so that a particulate heat storage material can be produced. The particulate heat storage material produced herein will be described as Example 5 in the following description.

According to the present embodiment, by a further addition of inorganic powder to an addition of sodium acetate, when the heat storage material solidifies even at ambient temperature to become a solid-state heat storage material, the solid-state heat storage material becomes rigid. Thus, a free-flowing, fine particulate heat storage material in a powder/granular form can be produced by pulverizing the solid-state heat storage material.

That is, the particulate heat storage material obtained in accordance with the present embodiment is being in a powder/granular form having fluidity at ambient temperature, and thus the heat storage material can avoid being treated in a supercooled liquid state. Thereby, storage as well as transportation of the heat storage material is made easy.

Further, although storage stability of a heat storage material in a supercooled liquid state is prone to be poor because a phase change into a solid state and the like may occur when the heat storage material is stored for a long period of time at ambient temperature, the particulate heat storage material in the present embodiment is originally in a solid state and thus does not undergo a phase change during storage, thereby achieving a high long-term storage stability.

Next, a method for manufacturing the heat storage device 110 in which the above-described particulate heat storage material is employed, will be described.

The heat storage device 110 in the present embodiment can be utilized, for example, as a heat storage device capable of being mounted to an internal combustion engine of a vehicle (not illustrated), and can warm up the internal combustion engine by discharging stored heat as necessary.

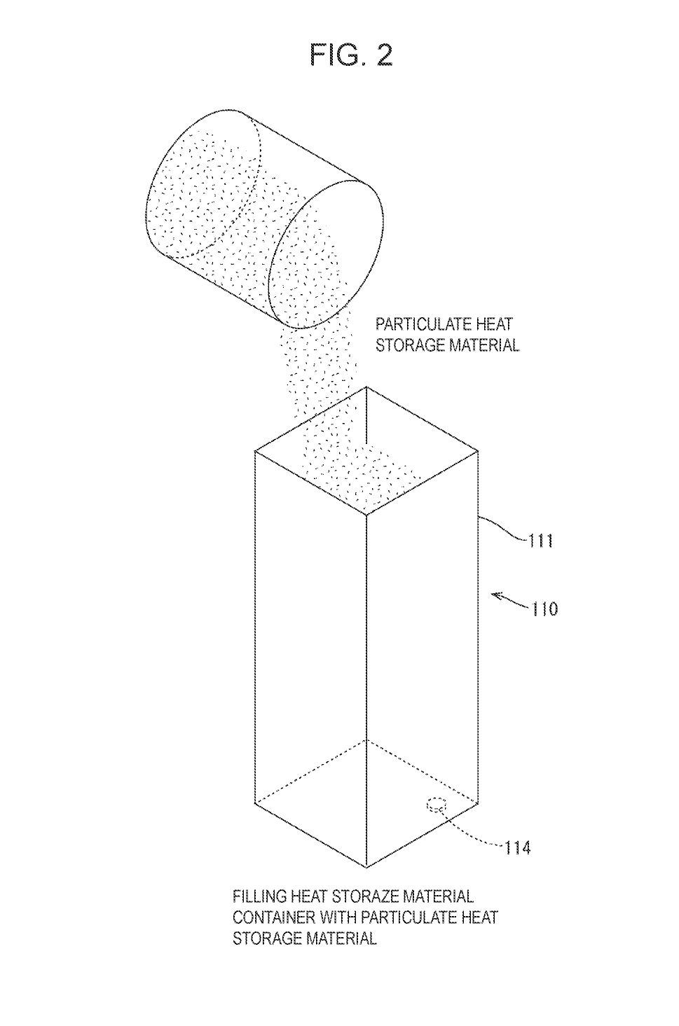

The heat storage device 110 is, as illustrated in FIG. 2, configured to include a heat storage material container 111 that is sealable, the particulate heat storage material to be filled in the heat storage material container 111, and a nucleation device 114 that is to be enclosed in the heat storage material container 111 together with the particulate heat storage material.

The heat storage material container 111 is a metal container made of stainless steel and the like having a high corrosion resistance as well as a high thermal conductivity, or a resin container made of a synthetic resin and the like, and is formed in a shape capable of being mounted to an internal combustion engine of a vehicle. In the present embodiment, the heat storage material container 111 corresponds to a heat conductor for directly conducting heat to the internal combustion engine.

The particulate heat storage material is a heat storage material in a powder/granular form described in detail as above, and is a heat storage material kept in a stable state having a high physical stimulus resistance and high long-term storage stability.

The nucleation device 114 is a device such as an ultrasonic element and leaf spring that generates physical stimuli, and can stimulate the heat storage material in a supercooled state to cause its nucleation.

To produce the heat storage device 110, first, the nucleation device 114 is housed within the heat storage material container 111. Then, in the filling the heat material, a prescribed amount of the particulate heat storage material manufactured as described above is filled in the heat storage material container 111 that is housing the nucleation device 114, and the heat storage material container 111 filled with the particulate heat storage material is sealed to complete the heat storage device 110.

Here, since the particulate heat storage material in the present embodiment is being in a powder/granular form having fluidity at ambient temperature, a filling operation of the heat storage material into the heat storage material container is made simple as compared to the liquid heat storage material in a supercooled state, and thereby a workability in the manufacturing operation of the heat storage device 110 can be enhanced.

Properties of examples and comparative example, and evaluation results of workability at the filling the heat materials are shown below.

### Evaluation Standard of Workability

Excellent: Filling operation was very simple.

Good: Filling operation was simple.

Poor: Filling operation was complex.

TABLE 2

| | | Filling |
|---|---|---|
| | Properties of Heat storage materials | Workability |
| Example 1 | Free-flowing powder/granular | Excellent |
| Example 2 | Free-flowing powder/granular | Excellent |
| Example 3 | Free-flowing powder/granular | Excellent |
| Example 4 | Slightly damp powder/granular | Good |
| Example 5 | Slightly damp non-uniform powder | Good |
| Comparative | Highly Viscous and Soft | Poor |
| Example | Unable to be processed into powder form | |

As described above, according to the particulate heat storage materials employed in Examples 1 to 4, by a further addition of inorganic powder to an addition of sodium acetate, the particulate heat storage materials were readily able to be in a powder/granular form having fluidity under ambient temperature as compared to the heat storage material in Comparative Example in which sodium acetate was solely dissolved in water. Thereby, the particulate heat storage material was easily able to be filled in the heat storage material container.

### Second Embodiment

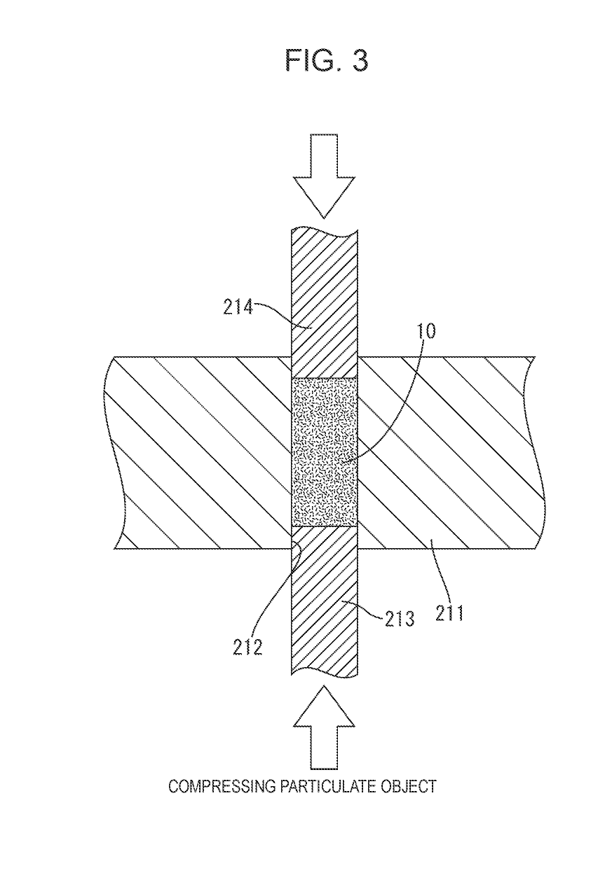

Next, a second embodiment is described while referencing FIG. 3.

In the second embodiment, a pellet-type heat storage material 10 in which a heat storage material is molded in a pellet form is employed, where the particulate heat storage material produced in the first embodiment is compressed in the compressing a particulate object to be in a pellet form.

Specifically, as illustrated in FIG. 3, a molding hole 212 that is shaped like a round hole penetrating in an up-down direction is provided in a molding die 211, and a lower mold 213 is being inserted into the molding hole 212 from downward side. Then, in a state where the lower mold 213 is being inserted into the molding hole 212, a prescribed amount of a particulate heat storage material is thrown into the molding hole 212 from upward side, and an upper mold 214 is inserted thereinto further from the upward side. Then, the particulate heat storage material is compressed to be pelletized by sandwiching the particulate heat storage material from both sides in the up-down direction with the upper mold 214 and the lower mold 213, and thereby the pellet-type heat storage material 10 having a substantially columnar-shape is molded. Note that, a force applied for compressing the particulate heat storage material with the upper mold 214 and the lower mold 213 is not less than 10 MPa, preferably from 20 to 30 MPa, and a heat conducting performance can be enhanced by increasing a density of the pellet-type heat storage material 10 as compared to that having a lower density. Also note that in regard to the heat conducting performance, the pellet-type heat storage material 10 to which a compression force of 10 MPa has been applied and the pellet-type heat storage material 10 to which a compression force of 30 MPa has been applied are heated on a hot plate, and changes in their appearances are observed. The pellet-type heat storage material 10 to which the compression force of 30 MPa has been applied is observed to show a greater change in its appearance, which indicates a phase change, as compared to that to which the compression force of 10 MPa has been applied, which indicates that a thermal conductivity of the pellet-type heat storage material having a high density is enhanced as compared to that having low density.

In the present embodiment, the particulate heat storage material that is stable enough not to be nucleated, is compressed into a pellet form so as to make a shape and dimensions of the pellet-type heat storage material 10 uniform. Thus, a dust is less likely to fly apart and the pellet-type heat storage material 10 is less likely to adhere to other members as compared to a case of the heat storage material staying in a powder/granular form, not to mention an achievement of a high handling property. Thereby, further enhancements in handling properties of the heat storage materials can be achieved.

The evaluation results of compression workability are shown below.

### Evaluation Standard of Compression Workability

Good: Compression and Pelletization were easy.

Fair: Pelletization was possible, regardless of difficulties in compression molding because of the hardness.

TABLE 3

| | Compression Workability |
|---|---|
| Example 1 | Good |
| Example 2 | Good |
| Example 3 | Good |
| Example 4 | Good |
| Comparative Example | Fair |

### OTHER EMBODIMENTS

The technology disclosed in the present specification is not limited to the preceding recitations and/or the embodiments described using the drawings, and various aspects such as the following should be construed to be included.

(1) In the above embodiments, heat storage materials having inorganic powder content of 50 mass % with respect to the total amount of the heat storage material are produced. However, the content of the inorganic powder is not limited thereto, and the inorganic powder content may be not greater than 50 mass % with respect to the total amount of the heat storage material, and may be approximately 55 mass % or 60 mass % with respect to the total amount of the heat storage material.

(2) In the above embodiments, the pellet-type heat storage material 10 is configured in a substantially cylindrical shape. However, the shape of the pellet-type heat storage material is not limited thereto, and the pellet-type heat storage material may be configured in a tablet shape or in a grain-like shape.

(3) In the above embodiments, the heat storage material container 111 of the heat storage device 110 is configured in a box shape. However, the shape of the heat storage material container is not limited thereto, and may be configured in an arcuate-type jacket-like shape to be mounted on an outer periphery of an internal combustion engine.

(4) In the above embodiments, the heat storage material container 111 of the heat storage device 110 is configured to directly conduct heat to an internal combustion engine. However, the configuration is not limited thereto, and the heat storage material container may be configured such that heat generated from the heat storage material is conducted to an exterior through a heat conductive member protruding toward outside of the heat storage material container from inside thereof.

What is claimed is:

1. A method for manufacturing a heat storage device, the heat storage device including:
a heat storage material containing sodium acetate and inorganic powder, the heat storage material undergoing a phase change between a liquid state and a solid state;
a heat storage material container configured to enclose the heat storage material;
a nucleation device configured to phase-change the heat storage material from a liquid state to a solid state; and
a heat conductor configured to conduct heat between the heat storage material and an outside of the heat storage material container;
the method comprising:
forming a heat storage material that is particulate and in a powder/granular form by mixing the sodium acetate and the inorganic powder; and
filling the heat storage material container with the heat storage material that is particulate obtained in the forming a heat storage material.

2. The method for manufacturing a heat storage device according to claim 1, wherein the forming a heat storage material comprises:
agitating a solution obtained by adding the inorganic powder into an aqueous solution in which the sodium acetate is dissolved in water;
solidifying the heat storage material in a liquid state obtained in the agitating a solution, by cooling the heat storage material so that the heat storage material is in a solid state; and
pulverizing the heat storage material in a solid state obtained in the solidifying the heat storage material so that the heat storage material is a particulate heat storage material.

3. A method for manufacturing a heat storage material, comprising:
agitating a solution obtained by mixing water and sodium acetate and thereafter further adding inorganic powder into the solution, while heating the solution;
solidifying the heat storage material in a liquid state obtained in the agitating a solution so that the heat storage material is in a solid state by cooling the heat storage material; and
pulverizing the heat storage material in a solid state obtained in the solidifying the heat storage material so that the heat storage material is in a powder/granular form.

4. The method for manufacturing a heat storage material according to claim 3, further comprising compressing a particulate object obtained by the pulverizing the heat storage material, into a pellet form.

5. A particulate heat storage material containing sodium acetate and inorganic powder.

6. A heat storage device comprising:
a particulate heat storage material in a powder/granular form containing sodium acetate and inorganic powder;
a heat storage material container configured to enclose the particulate heat storage material;
a heat conductor configured to conduct heat between the particulate heat storage material and an outside of the heat storage material container; and
a nucleation device configured to nucleate a liquid-state heat storage material in which the particulate heat storage material is being dissolved.
